(19) United States
(12) Patent Application Publication
(10) Pub. No.: US 2014/0278760 A1
(43) Pub. Date: Sep. 18, 2014

(54) AUTOMATED CONSULTATIVE METHOD AND SYSTEM

(71) Applicant: Ad Giants, LLC, Dallas, TX (US)

(72) Inventors: David E. Farmer, Holland, MI (US); Donovan Dillon, Plano, TX (US)

(21) Appl. No.: 14/210,757

(22) Filed: Mar. 14, 2014

Related U.S. Application Data
(60) Provisional application No. 61/786,816, filed on Mar. 15, 2013.

(51) Int. Cl. G06Q 30/02

(52) U.S. Cl. CPC G06Q 30/0201
USPC 705/7.29

(57) ABSTRACT

A computer program facilitates a consultation between an authorized user and a human consultant. During the consultation, the human consultant maps a user need to one or more marketing objectives. The consultant interacts with the computer program to identify one or more tactics that are relevant to accomplishing the one or more marketing objectives. The consultant or the user selects from the one or more tactics identified by the computer program to cause the computer program to identify marketing packages available to implement a selected tactic. The consultant facilitates selection of a marketing package by the authorized user to implement a selected tactic.

### CROSS-REFERENCE TO RELATED APPLICATION

This application claims the benefit of U.S. provisional patent application Ser. No. 61/786,816 filed Mar. 15, 2013.

### FIELD OF THE INVENTION

The present invention relates generally to a system for managing marketing programs using a web-based computer program to link consultants, advertising agencies, clients and media outlets for the dynamic creation, modification and placement of advertising materials. More particularly, the present invention relates to an interactive system wherein a client and a consultant create a customized marketing plan for the client using a consultation automation wizard.

### BACKGROUND OF THE INVENTION

Advertising programs typically are created by advertising agencies on behalf of clients that desire to advertise products and/or services locally, nationally, or both. The advertising agencies control the “assets” (the advertising materials to be used) and placement with the media. Thus, changes and customization for different local markets can be costly and time consuming since the client must return to the advertising agency each time.

Ad Giants, LLC is a next-generation marketing services company based in Dallas, Tex. Its flagship product, the Ad Giants ONE System®, is an intuitive, online marketing automation system that enables companies to protect and control their most valuable asset, their brand. It allows users to quickly and easily customize, order, and track corporate-approved marketing materials and campaigns for local use. It streamlines work flow, ensures field-level compliance to brand standards, reduces overhead, eliminates production waste, tracks results and boosts marketing ROI.

The Ad Giants ONE system provides customized localization for business marketing. The ONE system is a proprietary simple-to-use online system that enables a business user to store, manage, customize, localize, personalize, distribute and fulfill all of the company's marketing content. The system saves valuable time, eliminates waste, reduces field support personnel and, most importantly, helps maintain total brand consistency. The Ad Giants ONE system can meet present and future needs. It is simple to use and requires little to no user training. The system lowers costs and improves the end-to-end workflow. It can manage back-end vendors for fulfillment. The Ad Giants ONE system is continuously improved with the addition of new features.

U.S. Pat. No. 7,596,561, issued on Sep. 29, 2009, covers a system for marketing management including dynamic advertisement creation and customization. An authorized user connects to a database through the Internet to access and modify any of a plurality of advertisements each including one or more templates for creating a display of the stored advertisement. The system displays a wiseguy for interaction with the authorized user by speaking instructions, helpful hints, and questions and being interactive in response to inputs by the authorized user. U.S. Pat. No. 7,596,561 is incorporated herein by reference in its entirety.

U.S. Pat. No. 8,271,507, issued on Sep. 18, 2012, relates to a method for marketing management including dynamic advertisement creation and customization by the authorized user. The method enables a personalized message between the authorized user and a prospect, and an online response path for the prospect in the form of a personalized URL (pURL), while tracking and monitoring an activity of the prospect, allowing the authorized user to set qualifying thresholds related to the activity of the prospect and assign the prospect to at least one responder to follow-up and engage the prospect when the qualifying threshold is achieved. U.S. Pat. No. 8,271,507 is incorporated herein by reference in its entirety.

U.S. Patent Appl. Publ. No. 2011/0126121 A1, relates to a method for marketing management including authorized user modification of advertising assets stored in the database. A fulfillment party can remotely connect to the system for executing a marketing program including a professional advertisement created through the modification of a selected one of the modifiable advertising assets in response to an order from one of an advertising agency and the authorized user. U.S. Patent Appl. Publ. No. 2011/0126121 A1 is incorporated by reference herein in its entirety.

Users of the foregoing systems sometimes require human intervention to identify, define, plan, design, customize, order and execute marketing campaigns. Conventionally, such human intervention is provided by advertising agencies and personnel employed thereby. Such human consultation is typically inefficient, due to the time required to identify the need for marketing services and to plan and implement advertising campaigns. Such human consultations are also typically expensive and have historically been available only to large companies having the resources available to engage advertising agencies.

Additionally, human consultants are typically hired on the basis of prior experience and history in marketing, and typically also develop such expertise in limited areas. More than one consultant is typically required to implement different marketing campaigns, which further increases the inefficiency and cost of utilizing an advertising agency. Moreover, there does not exist an easy, repeatable method for augmenting or training human consultants except for investing the time required for the consultant to develop experience and history through design and development of actual marketing campaigns.

It would be desirable to provide a simple-to-use online system and method that enables a business user to create, store, manage, customize, localize, personalize, distribute and fulfill all of the company's marketing content, while efficiently allowing human intervention supported by the online system. Further, it would be desirable to provide a system and method for efficiently creating sophisticated and qualified individuals to act as qualified human consultants in support of a simple-to-use online marketing system. It would further be desirable to provide a consultative system and method for use by small and mid-size businesses (SMBs) who are looking for the same level of high-quality marketing presence that their larger competitors enjoy, but at a much more affordable cost, and to design a product that would allow SMBs to locate, create, plan, and execute top-of-the-line marketing campaigns that will help them grow their customers and build their businesses, all in one convenient location.

### SUMMARY OF THE INVENTION

In concordance with the instant disclosure, a simple-to-use online system that enables a business user to create, store, manage, customize, localize, personalize, distribute and fulfill all of the company's marketing content, while efficiently allowing human intervention supported by the online system, has surprisingly been discovered.

In one embodiment, an automated consultative system for marketing management includes a computer program that facilitates a consultation between an authorized user and a human consultant. During the consultation, the human consultant maps a user need to one or more marketing objectives, interacts with the computer program to identify one or more tactics that are relevant to accomplishing the one or more marketing objectives; selects from the one or more tactics identified by the computer program to cause the computer program to identify marketing packages available to implement a selected tactic; selects the desired marketing package to cause the computer program to incorporate the marketing package into a marketing plan; then publishes the marketing plan, allowing the computer program to facilitate selection of a marketing package by the authorized user to implement a selected tactic.

In another embodiment of the invention, an automated consultative system for marketing management includes a database storing a plurality of marketing packages for implementing a marketing campaign. An administrator server computer is connected to the database and is running a computer program. The system permits a login to the administrator server computer by an authorized user at a remote computer to access the database. The remote computer is a user computer having a processor which is remotely connected to the server computer. The remote computer displays tools for use by the authorized user. The remote computer further provides an interconnection with a human consultant for interaction with the authorized user upon receiving a request by the authorized user. The human consultant maps a user need to one or more marketing objectives, interacts with the computer program on the administrator server computer to identify one or more tactics that are relevant to accomplishing the one or more marketing objectives; selects from the one or more tactics identified by the computer program, the computer program further identifying marketing packages available to implement a selected tactic; selects the desired marketing package to cause the computer program to incorporate the marketing package into a marketing plan; then publishes the marketing plan, allowing the computer program to facilitate selection of a marketing package by the authorized user to implement a selected tactic.

In other embodiments, the computer program displays tools for use by the consultant for identification or selection of one or more of the objectives, tactics, and marketing packages. The computer program may further allow the consultant to capture information about the authorized user, and may allow the consultant to selectively annotate user information with notes and tasks. The computer program may optionally provide the consultant with information about authorized users assigned to the consultant and may allow the consultant to track execution of a selected marketing package. The computer program may provide a graphical representation of open marketing plans to allow one of the consultant and the authorized user to track marketing package implementation, progress and status.

The Ad Giants MODsocket® system and method contains a variety of industry-specific marketing, advertising, and interactive direct marketing templates, as well as consultation and other marketing services, and support tools for implementing, tracking and managing marketing campaigns.

The MODsocket method and system is an embodiment and extension of The ONE system designed to be used by small and mid-size businesses (SMBs) who are looking for the same level of high-quality marketing presence that their larger competitors enjoy, but at a much more affordable cost. Additionally, the MODsocket method and system enables human consultants as an optional new embodiment of the wiseguy feature identified in U.S. Pat. No. 7,596,561, and extends The ONE system to provide a consultation automation feature.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic block diagram of the communication interconnection between parties using the system and method according to the invention;

FIG. 2 is a flow diagram of the communication interconnection between parties using the system and method according to the invention;

FIG. 3 is an exemplary screen display of an interface for initiating a human consultation using the system and method according to the invention; and

FIG. 4 is a schematic block diagram of the automated consultative method and system according to the invention.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

The MODsocket method and system allows a User to: 1) Drive sales with professional marketing; 2) Delegate marketing execution so that the User can focus on running the business; and 3) Save time and money while growing the business. The MODsocket method and system provides: 1) Expert marketing advice; 2) A complete set of marketing resources; 3) The User's own convenient, affordable marketing department. By enabling a human consultant within the MODsocket method and system, the present invention allows human intervention supported by the consulting automation tool.

With reference to FIG. 1, a User, a Consultant and administrator server computer or terminal communicate through an Ad Giants server 10 connected to a User terminal 12, a Consultant terminal 14 and an Administrator terminal 16. The terminals communicate by any suitable means such as Internet connections for the terminals 12 and 14 and an Intranet connection for the terminal 16. The terminals can be, by way of non-limiting examples, personal computers, tablet computers, cell phones, PDA's.

A MODsocket website maintained by “Ad Giants” is operated on the server 10. The MODsocket.com website provides Do-It-Yourself (DIY) marketing resources and implementation assistance. However, a need has been identified wherein some Users of the automated systems require human intervention to identify, define, plan, design, customize, order and execute marketing campaigns. A MODsocket Personal Marketing Consultant is available to provide initial and ongoing consultation and marketing recommendations. The Personal Marketing Consultant is a member of a Virtual Marketing Team that provides turn-key marketing campaign design and execution and periodic campaign reviews and updates. The Consultant can be considered as an extension of the wiseguy described in the above-identified Ad Giants U.S. Pat. No. 7,596,561.

The method according to the present invention begins with a User login 20 at the MODsocket website. Once the User is identified or has entered information sufficient to be identified, the website displays a set of tools at “Display Tools” 22 that are available to the category of user. If the User desires a Human Consultant, a connection to a Human Consultant through a consultant terminal 14 (FIG. 1) is provided at “Connect to Consultant” request 24. In one embodiment, the Consultant 26 is quickly provided from an existing queue of qualified consultants trained to use the MODsocket method and system. Alternatively, the “Connect to Consultant” request 24 may initiate an appointment at a date and time selected by the User and a customer call-back by the assigned Consultant 26, as desired.

As shown in FIG. 3, once connected to the MODsocket website, a User may select a meeting with a Personal Consultant 32, or optionally may select a Do-it-yourself method 30. To facilitate the process, the User may submit preliminary information via a proprietary, simplified JumpStart Audit form. Once assigned to the User, the Consultant performs a review of the JumpStart submission in preparation for an initial consultation with the User to assess the needs of the User as a preliminary step to generating marketing recommendations.

Thus, a User starts the MODsocket process for working with a Personal Consultant with an initial consultation with the Personal Consultant. The Consultant may provide, as non-limiting examples, an introduction and presentation of Consultant credentials; an initial marketing review and marketing needs verification (preferably based on the JumpStart submission); an overview of the MODsocket process and services subscription options; and schedule a follow-up call where the marketing plan and recommendations will be provided by the Consultant to the User. The User may select a subscription option at this point and the initial consultation event with notes and To-Dos is captured in the consultation node.

Alternatively, after the introduction and presentation of the credentials of the Consultant, the MODsocket process proceeds as shown in FIG. 4. The Consultant develops a marketing plan 40. The objectives of the marketing plan process are: 1) Review User needs established in the initial consultation; 2) Develop marketing recommendations and tactics; and 3) schedule a follow-call to review and act on the marketing recommendations that the Consultant has developed.

The MODsocket method and system is built based on a philosophy that all marketing efforts, including the marketing efforts arranged through the MODsocket system, are intended to support a finite number of objectives. Each of the finite number of objectives is supported, in turn, by a finite set of tactics that are capable of meeting the objectives. The MODsocket system includes a plurality of predefined and customizable advertising packages that may be aligned with each of the tactics capable of meeting the finite number of objectives.

Thus, once the jumpstart evaluation is completed, the Consultant may proceed to inquiries regarding the needs of the User. The Consultant has received training in how to assess the needs of the User and to correlate those needs to a set of pre-defined Objectives, which are finite in number. Accordingly, the Consultant works with the User and user-supplied information supplied via the JumpStart audit to map the needs of the User to the Objectives, indicated at reference 42. The identified Objectives are fed to the Server 44, which in turn identifies a set of Tactics at reference 46 that are capable of meeting the Objectives identified at 42.

The Consultant selects an applicable Tactic at reference 48 from the Tactics identified at reference 46, for implementation as a marketing effort. The selected Tactic is received by the server 44, which further identifies various marketing packages at reference 50 offered through the MODsocket method and system that are available to accomplish the selected tactic. Upon identification of particular marketing packages at reference 50, the MODsocket method and system may insert a Store Package Content node for identified packages. The Store Package Content node may include key package information as well as the marketing objectives and tactics that the package supports. Information from the Store Package Content node may then be utilized by the Consultant to record and distribute meeting notes, and/or create and distribute marketing recommendations and plans, as further described below.

At reference 52, the Consultant selects one or more specific marketing packages to achieve the selected Tactic. The MODsocket consulting process & marketing plan automation stores the selected package data elements. As non-limiting examples, the store package type may include data elements such as: Package Title or Name; Package Description; Package Price; Package Image; Package Link/URL; and Package Objective/Tactic. The server 44 receives the selected marketing package and creates a marketing plan at reference 64.

The Consultant thereafter reviews the marketing plan with the User, shown at reference 66. The Consultant may make the marketing plan available to the User in advance of the marketing plan review, or may present it to the user in real time. The User selects and purchases recommended packages from the marketing plan at reference 68. Thereafter, the Consultant works with the user to ensure implementation of the selected package, while the MODsocket system and method provides tools for tracking the consultation, as well as for tracking implementation and execution of the marketing plan. In particular, the Consultant may include within the documentation of the MODsocket method and system certain Consultant's Notes 54 visible to only the Consultant and other administrative personnel, which the Consultant can create and edit at any time. Both the Consultant and the User may include a Meeting Notes Node 56. As a non-limiting example, the Meeting Notes Node 56 may be of the form shown in Table 3 below for display on a computer screen. As shown in Table 3, the MODsocket method and system allows population of the note node with freeform text areas, attachments and follow-up/checklist items. Threaded comments on the notes are also supported. Additionally, the Consultant is empowered to send meeting notes and amend notes after they are sent.

Additionally, the MODsocket method and system may allow the Consultant and the User to add to or adjust a Schedule 58 for implementing the marketing plan. The Consultant may further have access to Track Execution data 60 that allows the Consultant to track execution of the marketing plan. Optionally, the MODsocket method and system may provide tracking information to both the User and the Consultant 62. Tracking information 62 may be provided in a graphical format, such as red-yellow-green indicia or a timeline format, to provide an easily readable visual reference that allows both the User and the Consultant to track implementation and execution of the marketing plan.

The interaction between the User and the Consultant is coordinated by an Administrator through the Administrator terminal 16 (FIG. 1), which may be remote or local. The Administrator view generated by the MODsocket system displays an area for the Administrator to: view and edit all scheduled and historic consultations; view/filter consultations by date, Consultant and by User; view and set/edit consultant booking schedule; and assign/reassign Consultants to certain bookings.

According to the present invention, the Consultant creates a marketing plan by selecting recommended marketing objectives and tactics from a preset list of key marketing objectives and tactics. The MODsocket system presents the Consultant with a set of applicable MODsocket packages based on the selected objectives and tactics. The Consultant selects applicable packages, often with input from the User. The MODsocket system auto-creates the User's “Marketing Recommendations” based on the Consultant selections and typed explanatory text, then sends the auto-generated marketing plan to the Consultant and/or the User via email or presents the plan directly via the system. Threaded comments on the recommendations are supported.

The Consultant builds the marketing plan by entering descriptive text and selecting pre-determined objectives, tactics and associated store packages as can be displayed on a computer screen. As a non-limiting example, a template for the Consultant to use in entering text and selecting pre-determined objectives, tactics and associated store packages is shown in Table 1 below.

The plan is subsequently presented by the Consultant to the Client. During this presentation, the Client may elect to act on the recommendation by clicking the embedded link within the plan and purchasing the associated Package from the MODsocket Store.

As a non-limiting example, an auto-generated Marketing Plan view/template of the type generated by the MODsocket method and system is shown in Table 2 below.

TABLE 1
□ Understanding the Customer (Objective)

| | |
|---|---|
| □ Primary Research (Tactic) | Recommended Packages |
| | □ Web Survey |
| | □ Focus Group Package 1 |
| | □ Focus Group Package 2 |
| □ Secondary Research (Tactic) | Recommended Packages |
| | □ Report 1 |
| | □ Report 2 |
| | □ Report 3 |

□ Building the Brand

| | |
|---|---|
| □ Defining/Improving Business Identity | . . . |
| □ Developing/Improving Key Messaging | . . . |

□ Developing/Improving Visual Brand Elements . . .
□ Building Awareness

| | |
|---|---|
| □ Traditional advertising | . . . |
| □ Internet marketing | . . . |

| | |
|---|---|
| □ Social media | . . . |

□ Generating Demand

| | |
|---|---|
| □ Direct Sales | . . . |

| | |
|---|---|
| □ Referral Programs | . . . |

| | |
|---|---|
| □ Lead generation | . . . |

□ Supporting Sales
□ Collateral . . .

| | |
|---|---|
| □ Event Marketing | . . . |

□ Customer Engagement Systems . . .
Actions
CREATE RECOMMENDATIONS
AMEND RECOMMENDATIONS

TABLE 2
Introduction:
Editable text area with boilerplate text
Recommendation Overview:
Editable text area with boilerplate text
Recommended Objectives & Tactics
Objective 1: Editable text area with boilerplate text

| | |
|---|---|
| □ Understanding the Customer | Associated MODsocket |
| | Packages |

| | |
|---|---|
| □ Primary Research | Package Name: Focus Group Package 1 |

Description: This is the package
description . . .
Price: $X

| | |
|---|---|
| □ Secondary Research | Package Name: Report 3 |

Description: This is the package
description . . .
Price: $X

Objective 2: Editable text area with boilerplate text

| | |
|---|---|
| □ Building the Brand | Associated MODsocket Packages |

| | |
|---|---|
| □ Developing/Improving Visual | Package Name: |
| | Custom Logo Package |

| | |
|---|---|
| Brand Elements | Description: This is the package |
| | description . . . |

Price: $X

Summary & Next Steps:
Editable text area with boilerplate text
Actions
PREVIEW PLAN
PUBLISH PLAN

The user view generated by the MODsocket system displays an area for the User to submit jumpstart information and request a consultation. In a “My Marketing Journal” display area the User can view the consultation and recommendation history and the Meeting Notes 56. Key fields are Date, Item (Title), and Author. The “My Marketing Journal” display area may also permit the submission of a new jumpstart information and request for a new consultation.

The MODsocket method and system thus automates the consulting process and marketing plan creation. The MODsocket method and system effectively memorializes and communicates User interactions using a Notes feature and associated comments. The User thus has a view that shows all Consultant interactions, including filtered, user-viewable Notes, Plans, and Comments, which is accessible from the “My Marketing Journal” link on the MODsocket.com website. The MODsocket method and system also memorializes and communicates marketing recommendations, including marketing Plans and associated comments provided by the Consultant. Thus, the Consultant view generated by the MODsocket system and method may display an area for the Consultant to view scheduled and historic bookings and associated consultations; view users previously consulted with and their associated consultations; set/edit own booking availability with notification to an Administrator; schedule new/follow-up events/consultations; and create/edit/revise and send notes, next steps, recommendations for marketing plans, etc. to memorialize events/consultations. Additionally, the MODsocket method and system memorializes a User history by providing for a Journal that may include, as non-limiting examples, a chronology of Notes, Plans and associated comments.

TABLE 3

| Pre-Meeting Notes | |
|---|---|
| This is a pre-meeting note text area. It allows free-form text and | |
| basic wysiwyg formatting. This can be edited with revisions. | |
| The User cannot see this field in their journal. | |
| Meeting Notes | |
| This is a meeting notes text area. It allows free-form text and basic | |
| wysiwyg formatting. This can be edited with revisions. The User | |
| can see this field in their journal. | |
| Follow-up Items | |
| □ Item 1 | |
| □ Sub-item (can be checked off when completed) . . . | |
| □ Sub-item 2 | . . . |
| □ Another Sub-item | . . . |

Actions
SEND MEETING NOTES
AMEND MEETING NOTES
SCHEDULE NEXT MEETING

Advantageously, the MODsocket method and system additionally provides a mechanism is to introduce individuals to the skills necessary to become a Consultant, because the MODsocket system itself can be utilized as a training system. As noted previously, the MODsocket method and system is built based on a philosophy that all marketing efforts, including the marketing efforts arranged through the MODsocket system, are intended to support a finite number of objectives. Each of the finite number of objectives is supported, in turn, by a finite set of tactics that are capable of meeting the objectives. The MODsocket method and system, when applied as a method and system to train consultants to provide marketing support, easily and quickly trains consultants to see the world of marketing in light of the finite number of objectives utilized in the MODsocket method and system. Thus, after training using the MODsocket system and method, a Consultant is able to use the training to focus on customer needs, and to map those needs to the objective. Equally as important, Consultants trained using the MODsocket method and system of training are able to quickly apply automated filters to enable the Consultant to filter out things that do not apply, thus ensuring that the Consultant is not distracted and is able to efficiently provide support and assistance. The MODsocket method and system of training Consultants thus provides a way to efficiently and quickly acquire desired marketing experience instead of relying on a long career in which to acquire real-world experience. In fact, the MODsocket method and system of training is able to train Consultants having widely varying backgrounds and produce consultants having a requisite proficiency much faster than relying on real-world experience over a lifetime of practice. Put another way, the MODsocket method and system of training is able to quickly and easily create a qualified and trained Consultant having an augmented communication skillset without relying on a specific individually acquired skill set, which lowers the necessary pre-requisite consultant skill level over the skills needed to conventionally accomplish the same thing

Additionally, because a Consultant trained using the MODsocket method and system is taught to identify customer needs across every one of the finite objectives, a single Consultant is able to implement significantly different marketing campaigns which normally require multiple consultants to implement, thereby reducing cost and increasing efficiency over using a conventional advertising agency.

As a result, the MODsocket method and system of training, in combination with application of the MODsocket method and system itself, implements an automation of the consulting and the resource package discovery to enable a trained and qualified consultant to be able to focus on customer needs, to map the customer needs to the objective, and to apply MODsocket training to pick the right tactic. When the consultant function is properly performed, the automation built into the MODsocket method and system identifies packages that satisfy the needs of the client, so that the Consultant need not be continuously aware of new packages and programs capable of implementing a tactic for achieving an objective.

The MODsocket method and system of training may also be used to continuously improve the services provided to customers. Because all transactions are monitored by an Administrator, additional modules may be implemented to ensure that the quality of the Consultant remains aligned with a desired quality and quantity of marketing program fulfillment. As a non-limiting example, the Administrator may be able to track a Consultant's performance using any applied metric, such as number of consulting meetings, amount of programs sold, speed of program implementation, satisfaction of the customer, and the like.

The MODsocket method and system thus provides a User with access to a complete team of marketing professionals: strategist, analyst, designer, and copywriter, project manager, and other specialized resources as required. The MODsocket method and system automates the delivery of marketing resources, while at the same time providing a qualified and trained Consultant that assists the User with defining and executing the right marketing program for his/her business. By automating the process for delivering marketing resources, MODsocket Users have efficient access to a host of professional marketing resources, including: expert consultation; libraries of print, email, direct mail, interactive, social media and broadcast campaigns; mobile marketing; and marketing services including custom design, research and more. Additionally, the MODsocket method and system of training ensures that a properly qualified and trained Consultant is sufficiently knowledgeable and experienced to be able to effectively and efficiently assist the User in accessing the proper resources. The MODsocket method and system also continuously improves the delivery of marketing resources in accordance with industry best practices, even as the MODsocket system revolutionizes the industry. The MODsocket system provides the people, processes, and tools the User needs to help his/her business stand out and succeed.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An automated consultative system for marketing management, comprising:
a computer program that facilitates a consultation between an authorized user and a human consultant wherein, during the consultation, the human consultant:
a) maps a user need to one or more marketing objectives;
b) interacts with the computer program to identify one or more tactics that are relevant to accomplishing the one or more marketing objectives;
c) selects from the one or more tactics identified by the computer program to cause the computer program to identify marketing packages available to implement a selected tactic; and
d) facilitates selection of a desired marketing package by the authorized user to implement a selected tactic.

2. The automated consultative system of claim 1, wherein the consultant selects the desired marketing package to cause the computer program to incorporate the desired marketing package into a marketing plan, and publishes the marketing plan to the authorized user.

3. The automated consultative system of claim 1, wherein the computer program displays tools for use by the consultant for identification or selection of one or more of the objectives, tactics, and marketing packages.

4. The automated consultative system of claim 1, wherein the computer program allows the consultant to capture information about the user.

5. The automated consultative system of claim 4, wherein the computer program further allows the consultant to selectively annotate user information with one or more of notes, comments, tasks, recommendations, schedules, plans, and progress reports.

6. The automated consultative system of claim 1, wherein the computer program allows the consultant to track execution of a selected marketing package.

7. The automated consultative system of claim 5, wherein the computer program provides a graphical representation of open marketing plans to allow one of the consultant and the authorized user to track one or more of marketing package implementation, progress and status.

8. The automated consultative system of claim 1, wherein an administrative user is able to track the performance of the consultant.

9. The automated consultative system of claim 8, wherein interaction between the user and the Consultant is coordinated by an Administrator through an Administrator terminal.

10. An automated consultative system for marketing management, comprising:
a database storing a plurality of marketing packages for implementing a marketing campaign;
an administrator server computer connected to said database, said server computer running a computer program;
the remote computer providing an interconnection with a human consultant for interaction with an authorized user upon receiving a request by the authorized user, wherein computer program enables the human consultant to
a) map a user need to one or more marketing objectives;
b) interact with the computer program on the administrator server computer to identify one or more tactics that are relevant to accomplishing the one or more marketing objectives;
c) select from the one or more tactics identified by the computer program, the computer program further identifying marketing packages available to implement a selected tactic; and
d) facilitate selection of a marketing package by the authorized user to implement a selected tactic.

11. The automated consultative system of claim 10, wherein the consultant selects the desired marketing package to cause the computer program to incorporate the desired marketing package into a marketing plan, and publishes the marketing plan to the authorized user.

12. The automated consultative system of claim 10, wherein the computer program displays tools for use by the consultant for identification or selection of one or more of the objectives, tactics, and marketing packages.

13. The automated consultative system of claim 10, wherein the computer program further allows the consultant to selectively annotate user information with one or more of notes, comments, tasks, recommendations, schedules, plans and progress reports.

14. The automated consultative system of claim 10, wherein the computer program allows the consultant to track execution of a selected marketing package.

15. The automated consultative system of claim 14, wherein the computer program provides a graphical representation of open marketing plans to allow one of the consultant and the authorized user to track one or more of marketing package implementation, progress and status.

16. The automated consultative system of claim 10, wherein an administrative user is able to track the performance of the consultant.

17. An method for providing an automated consultative system for marketing management, comprising the steps of:
a. identifying a first set of marketing objective for a user;
b. mapping a user need to one or more of the marketing objectives;
c. identifying one or more tactics relevant to accomplishing the one or more marketing objectives;
d. selecting from the one or more tactics to meet the marketing objective;
e. identifying one or more marketing packages available to implement a selected tactic; and
f. selecting one or more of the marketing packages to implement a selected tactic.

18. The method of claim 17, further comprising the step of:
g. executing the selected one or more marketing packages.

19. The method of claim 18, further comprising the step of:
h. tracking the execution of the selected one or more marketing packages.

20. The method of claim 19, further comprising the step of:
i. annotating the information about the user with one or more of notes, comments, tasks, recommendations, schedules, plans and progress reports.
